(19) United States
(12) Patent Application Publication
(10) Pub. No.: US 2012/0080140 A1
(43) Pub. Date: Apr. 5, 2012

(54) CLOSURE BEAD

(76) Inventor: Meshia Rene Arebalo, San Angelo, TX (US)

(21) Appl. No.: 13/031,066

(22) Filed: Feb. 18, 2011

Related U.S. Application Data
(60) Provisional application No. 61/389,035, filed on Oct. 1, 2010.

(51) Int. Cl. A44C 25/00; B32B 37/00

(52) U.S. Cl. 156/166; 63/38

(57) ABSTRACT

A closure bead provides a self-closing feature for closing the ends of stringing material. When jewelry is prepared, the closure bead may be used to close the ends of the stringing material after attaching the clasp, extension, jump ring, pendant, or the like. The closure bead may provide self-sealing closures that are designed to seal the ends of stringing elements, such as jewelry strands, ski ropes, climbing ropes, tool hangers, picture hangers, organizers, working ropes and the like. The closure bead may be used in various ways in various fields. For example, the device may be used in the medical field as a closure device, or in computers, electronics or children's toys as a way to seal wiring.

### CROSS-REFERENCE TO RELATED APPLICATIONS

This application claims the benefit of priority of U.S. Provisional patent application No. 61/389,035, filed Oct. 1, 2010, the contents of which are herein incorporated by reference.

### BACKGROUND OF THE INVENTION

The present invention relates to methods and apparatus for jewelry making and, more particularly, to a closure bead that simply and securely closes the ends of stringing material.

There are many types stringing material used in making jewelry. Unfortunately, there are few methods of closing the ends of the stringing material after attaching the clasp, extension, jump ring or creating a pendant.

As can be seen, there is a need for apparatus and methods for closing ends of stringing material.

### SUMMARY OF THE INVENTION

In one aspect of the present invention, a closure bead comprises a bead body; a passage passing through the bead body; a chamber extending at least partially into the bead body; and an adhesive adapted to contact a stringing material passing into the chamber.

In another aspect of the present invention, a method for closing an end of a stringing material comprises passing the stringing material through a passage through a closure bead; threading the stringing material through a structural element; and inserting the end of the stringing material into a chamber of the closure bead, the chamber adapted to contain an adhesive for securing the stringing material.

These and other features, aspects and advantages of the present invention will become better understood with reference to the following drawings, description and claims.

### BRIEF DESCRIPTION OF THE DRAWINGS

FIG. 1 is a perspective view of a closure bead according to an exemplary embodiment of the present invention;

FIG. 2 is a cross sectional view of the closure bead of FIG. 1;

FIG. 3 is a close-up cross sectional view of the closure bead of FIG. 1;

FIG. 4 is a cross sectional view of a closure bead according to an alternate embodiment of the present invention;

FIG. 5 is a cross sectional view of a closure bead according to an alternate embodiment of the present invention;

FIG. 6 is a cross sectional view of a closure bead according to an alternate embodiment of the present invention;

FIG. 7 is a cross sectional view of a closure bead according to an alternate embodiment of the present invention; and

FIG. 8 is a cross sectional view of a closure bead according to an alternate embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, an embodiment of the present invention provides a closure bead that provides a self-closing feature for closing the ends of stringing material. When jewelry is prepared, the closure bead may be used to close the ends of the stringing material after attaching the clasp, extension, jump ring, pendant, or the like. The closure bead may provide self-sealing closures that are designed to seal the ends of stringing elements, such as jewelry strands, ski ropes, climbing ropes, tool hangers, picture hangers, organizers, working ropes and the like. The closure bead may be used in various ways in various fields. For example, the device may be used in the medical field as a closure device, or in computers, electronics or children's toys as a way to seal wiring.

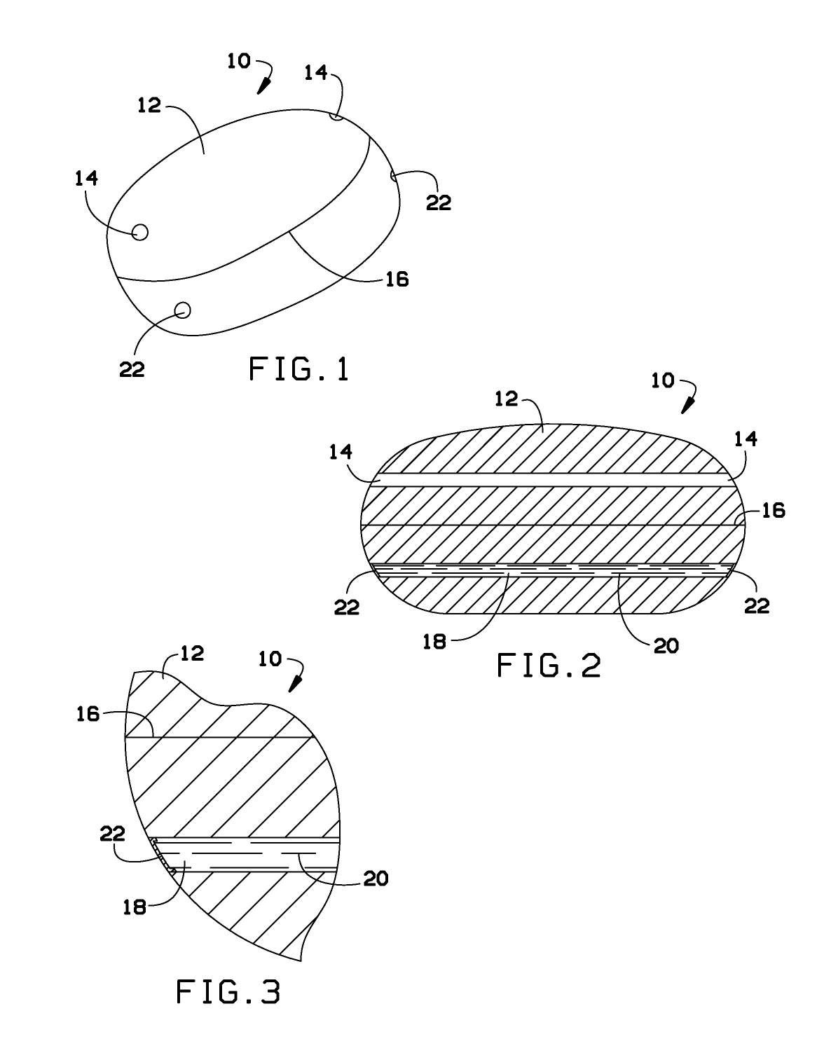

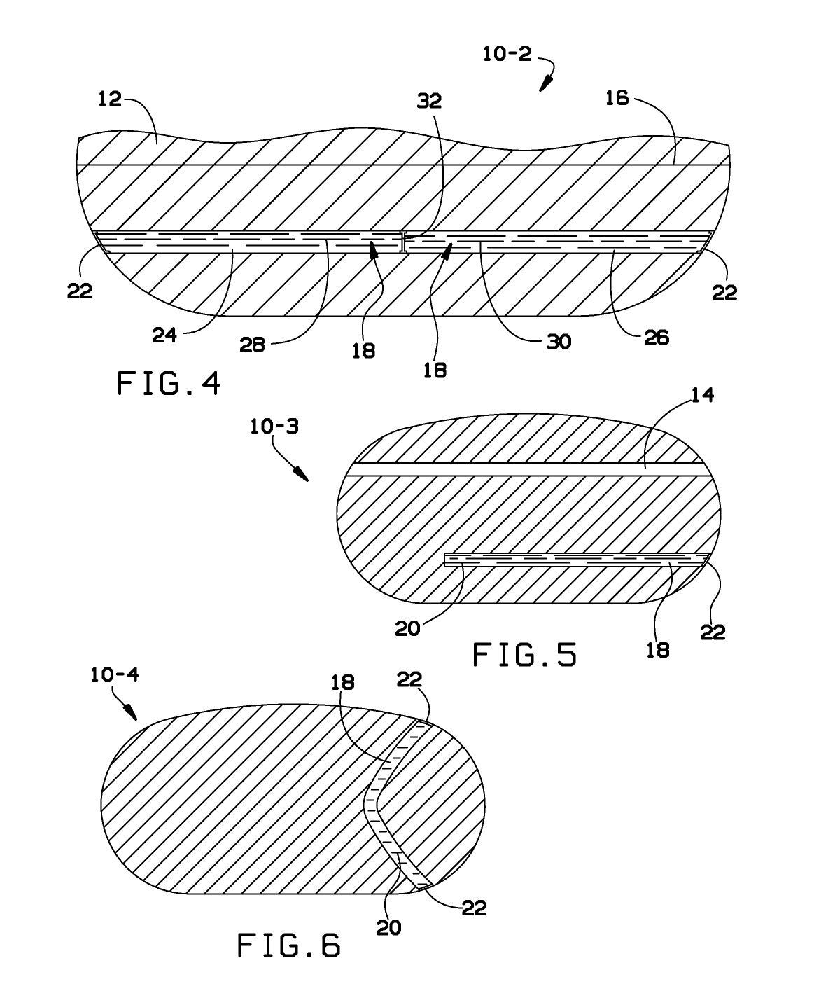

Referring now to FIGS. 1 through 3, a closure bead 10 may include bead body 12 having a passage 14 therethrough. The passage 14 may be adapted to allow stringing material to pass through the closure bead 10. A chamber 18 may be formed through the closure bead 10. The chamber 18 may include a supply of adhesive substance 20, such as glue or a quick drying gel glue. Ends of the chamber 18 may be sealed by end seals 22 at each end thereof. The end seals 22 may be removed by the user by various methods. For example, the end seals 22 may be pried off or may simply be punctured with a tool or even with the stringing material (not shown). In some embodiments, only one of the end seals 22 may be removed by the user to insert the string material into the chamber 18. The end seals 22 may be formed of, for example, a foil material. In some embodiments, the end seals 22 may be formed of the same material as the closure bead itself.

The bead body 12 may be formed of, for example, metal, plastic, gemstone, glass, shell, wood, pearl, crystal, bone, resin, seed, acrylic, and the like. The size and shape of the closure bead 10 may vary according to application and design. For example, for some jewelry applications, the closure bead 10 may be a sphere having a diameter of about 0.25 inch. The bead body 12 may include a dividing line 16 to divide the bead body 12 into two portions—one portion including the passage 14 and one portion including the chamber 18.

In some embodiments, the chamber 18 may include a portion having a larger diameter and a portion having a smaller diameter. In this embodiment, if the user inserts stringing material through the chamber 18 and ties a knot in the end passing through the stringing material, the user may pull the knot into the larger diameter portion, thereby hiding the knot inside the closure bead 10. Additionally, the smaller diameter portion may be sized smaller than the knot, thereby further securing the stringing material and preventing the stringing material from being pulled out through the chamber 18.

Referring to FIG. 4, the chamber 18 of a closure bead 10-2 may include a two-part epoxy 24, 26, disposed a divided chamber 18. The chamber 18 may be divided with a divider 32. Similar to the embodiment of FIGS. 1 through 3, ends of the chamber 18 may be sealed with end seals 22. During use, a user may pass a stringing material through the chamber 18, causing the resin and hardener of the two-part epoxy 24, 26 to mix, react and cure, thereby securing the stringing material.

Referring to FIG. 5, the chamber 18 may not extend entirely through a closure bead 10-3. Similar to the previous embodiments, the end seal 22 may seal the end of the chamber 18.

Referring to FIG. 6, the chamber 18 may curve through a closure bead 10-4. This embodiment may or may not include the passage 14, as shown in FIGS. 1-5. Similar to the previous embodiments, end seals 22 may seal the ends of the chamber 18.

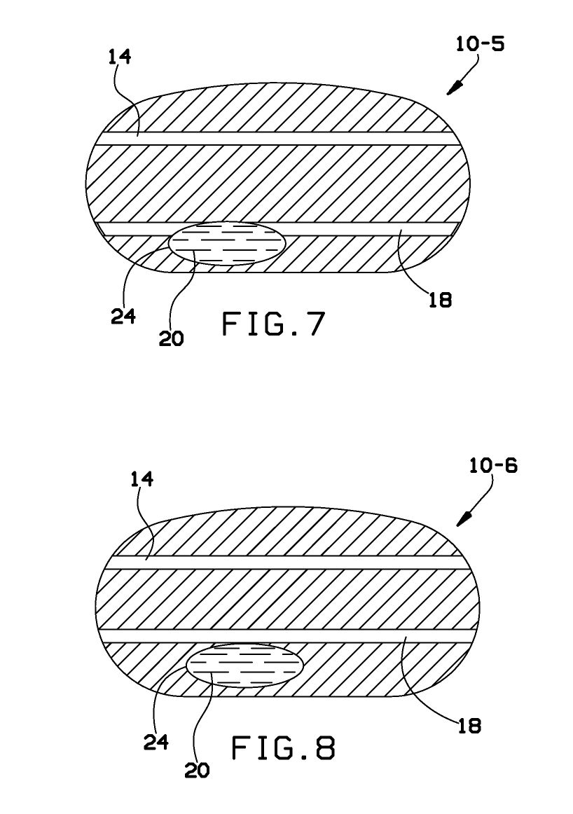

Referring to FIG. 7, a bladder 24 may be disposed in the path of the chamber 18 of a closure bead 10-5. The bladder 24 may contain the adhesive 20. When the stringing material is passed through the chamber 18, the bladder 24 may break, releasing the adhesive 20. In this embodiment, the end seals 22 are not required, as there is no adhesive that may be released prior to use. In this embodiment, there may be an indicia provided to indicate which opening is for the passage 14 and which opening is for the chamber 18, allowing the user the pass the stringing material through the closure bead 10-5 appropriately.

Referring to FIG. 8, the bladder 24 may be disposed outside of the path of the chamber 18 of a closure bead 10-6. This embodiment may allow the stringing material to pass through the chamber 18 without getting coated with adhesive. The closure bead 10-6 may include a means to release the adhesive 20 from the bladder 24. For example, the closure bead 10-6 may be made of a resilient material that, when the closure bead 10-6 is compressed, causes the bladder 24 to break, releasing adhesive 20 into the chamber 18.

To use the closure bead, the user may string the stringing material through the passage 14 and thread the stringing material through a structural element, such as a clasp, extension, pendant, or the like. The end of the stringing material may then be passed into the chamber 18 and secured with the adhesive 20. In some embodiments, the stringing material may pass entirely through the chamber 18 and a knot in the stringing material may help secure it from being pulled back through the chamber 18.

It should be understood, of course, that the foregoing relates to exemplary embodiments of the invention and that modifications may be made without departing from the spirit and scope of the invention as set forth in the following claims.

What is claimed is:

1. A closure bead comprising:
a bead body;
a passage passing through the bead body;
a chamber extending at least partially into the bead body; and
an adhesive adapted to contact a stringing material passing into the chamber.

2. The closure bead of claim 1, further comprising at least one end seal closing the chamber within the bead body.

3. The closure bead of claim 1, wherein the adhesive is disposed within the chamber.

4. The closure bead of claim 1, wherein the adhesive is disposed within a bladder.

5. The closure bead of claim 4, wherein the bladder is disposed in a path of the chamber, wherein when the stringing material passes through the chamber, the bladder is adapted to break open, releasing adhesive into the chamber.

6. The closure bead of claim 4, wherein the bladder is disposed adjacent to a path of the chamber.

7. The closure bead of claim 1, wherein the chamber passes entirely through the bead body.

8. The closure bead of claim 1, wherein the chamber passes only partially into the bead body.

9. The closure bead of claim 1, wherein the adhesive includes a resin disposed in a first part of the chamber and a hardener disposed in a second part of the chamber, wherein the first part and the second part are separated.

10. A method for closing an end of a stringing material, the method comprising:
passing the stringing material through a passage through a closure bead;
threading the stringing material through a structural element; and
inserting the end of the stringing material into a chamber of the closure bead, the chamber adapted to contain an adhesive for securing the stringing material.
